(19) United States
(12) Patent Application Publication
(10) Pub. No.: US 2018/0077259 A1
(43) Pub. Date: Mar. 15, 2018

(54) UNIFIED DATA RENDERING FOR MULTIPLE UPSTREAM SERVICES

(71) Applicant: LinkedIn Corporation, Mountain View, CA (US)

(72) Inventors: Yawen Wei, Sunnyvale, CA (US); Yizhen Zhao, Pacifica, CA (US); Vien Duong Dinh, San Jose, CA (US); Michael Vander Lugt, Troy, MI (US)

(21) Appl. No.: 15/261,623

(22) Filed: Sep. 9, 2016

(51) Int. Cl. H04L 29/08; G06Q 30/02

(52) U.S. Cl. CPC H04L 67/2852; H04L 67/16; H04L 67/02; H04L 67/42; G06Q 30/0251; G06Q 30/0273; G06Q 30/0277

(57) ABSTRACT

Techniques for caching data are provided. A service initiates a call to a method of an object that represents a resource, where the call includes identification data that identifies a set of data. In response to receiving the call, a resource data manager that is separate from the service, reads resource configuration data that is associated with the resource and identifies, within the resource configuration data, multiple data layers that includes a first data layer and a second data layer. The resource data manager establishes a connection with the first data layer. The resource data manager sends the identification data to the first data layer. The resource data manager receives the set of data from one of the plurality of data layers. The resource data manager sends the set of data to the service.

### TECHNICAL FIELD

The present disclosure relates to implementing an electronic data rendering service for multiple upstream services in a networked environment.

### BACKGROUND

The Internet has enabled the delivery of electronic content to billions of people. Sophisticated techniques have been explored and implemented to identify content that is relevant to viewers that are requesting other content. Such techniques may involve taking into account which web sites a viewer has visited in the past in order to identify content in which the viewer might be interested. The sophistication of such techniques has led to large and complicated code bases. Software developers of services that implement those techniques have to be intimately aware of not only the logic of selecting the relevant content, but also rendering the content appropriately. As the number of tasks that services must implement increases, other aspects of the software development process also increase, such as the time to write the code for the services, the chances of errors or bugs in the code, and the time to rollout new or updated services to production in order to serve online traffic.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example server system that processes content requests, in an embodiment;

FIGS. 2A-2B include a flow diagram that depicts a process for unified data rendering, in an embodiment;

FIG. 3 is a flow diagram that depicts a process for clearing a cache, in an embodiment;

FIG. 4 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Techniques for implementing data gathering and rendering once for multiple upstream services are provided. Multiple services process requests for content items of various types, each service processing requests for content items of a different type. Instead of each service being responsible for retrieving and rendering content items in addition to determining the content items, such retrieving and rendering is performed by a separate service, with which the multiple services interact. In this way, data gathering and rendering is implemented once.

Techniques for chaining data layers are also provided. Instead of requiring a software developer to implement data access from, and data update of, multiple data sources, the software developer merely defines a configuration for each data source and a built-in software framework, based on a set of configurations, handles the details of establishing data connections to the data sources, reading data from the data sources, and updating the data sources.

Techniques for reducing the delay in clearing a cache are also provided. In one approach, input is received that indicates a cache or other volatile storage should be cleared. Based on the input, a version number is increased and the version number is added to a key of each data item that is used to search the cache. Because the newly “versioned” key is not found in the cache, a cache miss is triggered and a request for the data item is made to other storage.

While the following description includes examples in the context of content delivery campaigns, embodiments are not so limited. Instead, embodiments are applicable to different types of content and different contexts.

### System Overview

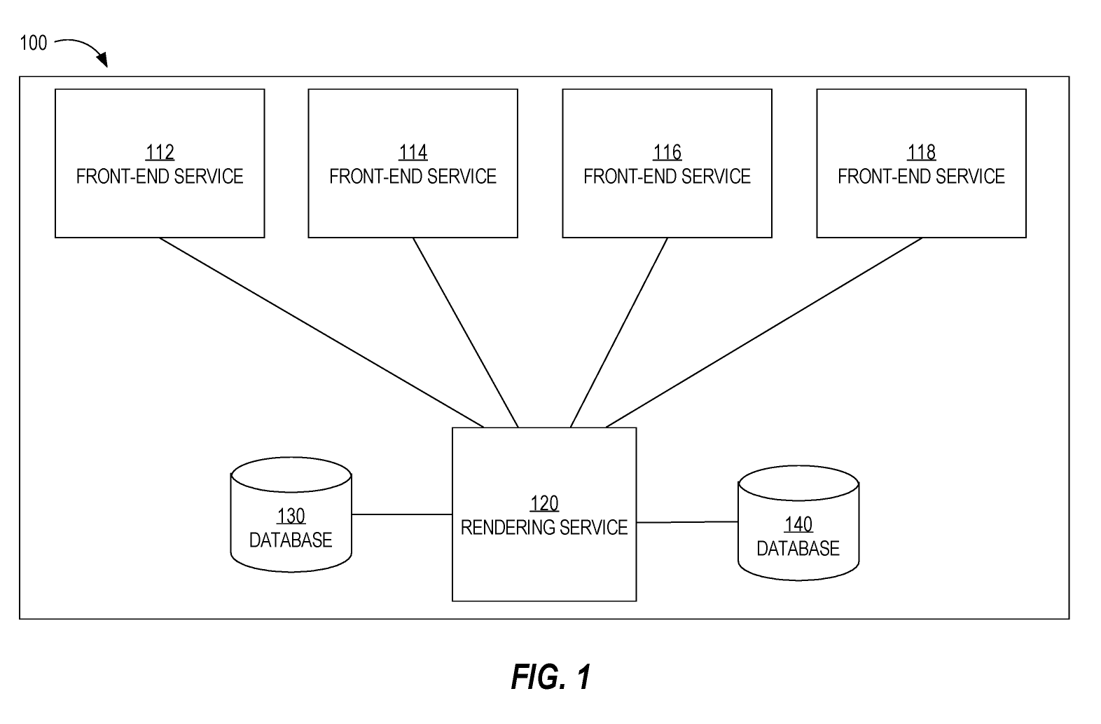

FIG. 1 is a block diagram that depicts an example server system 100 that processes content requests, in an embodiment. Server system 100 includes multiple front-end services 112-118 that receive content requests from client devices (not shown) over a computer network, such as a LAN, WAN, or the Internet. Example client devices include desktop computers, laptop computers, tablet computers, wearable devices, video game consoles, and smartphones.

Each of front-end services 112-118 is hosted on one or more computing devices, such as in a data center that comprises storage devices and computing devices hosting different services.

In an embodiment, content requests from different types of client devices may be handled by different front-end services 112-118. For example, requests from tablet computers may be processed by front-end service 112, requests from smartphones may be processed by front-end service 114, and requests from desktop computers may be processed by front-end service 116.

Additionally or alternatively, different types of content requests may be handled by different front-end services 112-118. For example, content requests of a first type may be processed by front-end service 112 and content requests of a second type may be processed by front-end service 114. Specific examples of types of content include text ads, dynamic ads, and sponsored updates.

Additionally or alternatively, different front-end services receive requests from different sources. For example, front-end service 112 receives content requests from one source and front-end service 114 receives content requests from another source. As a specific example, one source may be any client device that initiates a content request in response to requesting a web page of a particular web site (which may be hosted or provided by server system 100 or an entity that provides server system 100) while another source may be a third-party content exchange that requests content items that match certain criteria and that are to be delivered to client devices that interact (directly or indirectly) with that third-party content exchange, such as DoubleClick.

In either of these three instances, one or more services (e.g., hosted on computing devices that are different from computing devices hosting a front-end service) may receive request traffic and send content requests to the appropriate front-end service, based on, for example, the types of content requested and/or the types of client device submitting the content requests.

In one scenario, a single request for a web content from a client device may result in multiple requests being generated by the client device, each of the multiple requests being processed by a different one of front-end services 112-118. For example, web content may include (1) space (e.g., in the middle of a page) to display a feed that includes one or more sponsored updates and (2) space (e.g., on the right side of the page) to display dynamic or static ads. In this example, at least two different requests are submitted, one that is processed by one front-end service and another that is processed by another front-end service.

While each of front-end services 112-118 might implement different functionality (e.g., how to select a content delivery campaign from among multiple content delivery campaigns), each of front-end services 112-118 perform similar operations, such as retrieving content items associated with content delivery campaigns, managing a cache or a hierarchy of storage devices, and/or rendering the content items.

Server system 100 includes rendering service 120, which is described in more detail below. Server system 100 may include other services upon which front-end services 112-118 and rendering service 120 rely but that are not depicted in server system 100. For example, server system 100 may include another service that determines which content delivery campaigns should be used to respond to content requests that front-end services 112-118 from remote client devices. In such an embodiment, front-end services 112-118 are primarily responsible for communicating with remote clients (e.g., receiving and handling content requests from the remote clients), retrieving user information based on cookies, checking authentication, etc.

Server system 100 also includes databases 130 and 140. Each of databases 130 and 140 may be implemented using one or more storage devices. Databases 130 and 140 may store the same type of data or may store different types of data. For example, database 130 may store data about content delivery campaigns and database 140 may store data about content items that are associated with the content delivery campaigns. Although rendering service 120 is depicted as being communicatively connected to databases 130 and 140, additionally or alternatively, front-end services 112-118 (and/or other services not depicted) may be communicatively coupled to databases 130 and 140, such that front-end services 112-118 may request data from, and store data to, databases 130 and 140.

### Content Delivery Campaigns

A content provider establishes a content delivery campaign with a content delivery exchange, a part of which includes server system 100. A content delivery campaign includes (or is associated with) one or more content items. Thus, the same content item may be presented to users of multiple client devices. Alternatively, a content delivery campaign may be designed such that the same user is (or different users are) presented different content items from the same campaign. For example, the content items of a content delivery campaign may have a specific order, such that one content item is not presented to a user before another content item is presented to that users.

A content delivery campaign has a start date/time and, optionally, a defined end date/time. For example, a content delivery campaign may be to present a set of content items from Jun. 1, 2015 to Aug. 1, 2015, regardless of the number of times the set of content items are presented (“impressions”), the number of user selections of the content items (e.g., click throughs), or the number of conversions that resulted from the content delivery campaign. Thus, in this example, there is a definite (or “hard”) end date. As another example, a content delivery campaign may have a “soft” end date, where the content delivery campaign ends when the corresponding set of content items are displayed a certain number of times, when a certain number of users view, select or click on the set of content items, or when a certain number of users purchase a product/service associated with the content delivery campaign or fill out a particular form on a website.

A content delivery campaign may specify one or more targeting criteria that are used to determine whether to present a content item of the content delivery campaign to one or more users. Example factors include date of presentation, time of day of presentation, characteristics of a user to which the content item will be presented, attributes of a computing device that will present the content item, identity of the publisher, etc. Examples of characteristics of a user include demographic information, residence information, job title, employment status, academic degrees earned, academic institutions attended, former employers, current employer, number of connections in a social network, number and type of skills, number of endorsements, and stated interests. Examples of attributes of a computing device include type of device (e.g., smartphone, tablet, desktop, laptop), current geographical location, operating system type and version, size of screen, etc.

For example, targeting criteria of a particular content delivery campaign may indicate that a content item is to be presented to users with at least one undergraduate degree, who are unemployed, who are accessing from South America, and where the request for content items is initiated by a smartphone of the user. If one of front-end services 112-118 receives, from a computing device, a request that does not satisfy the targeting criteria, then that front-end service ensures that any content items associated with the particular content delivery campaign are not sent to the computing device.

Instead of one set of targeting criteria, the same content delivery campaign may be associated with multiple sets of targeting criteria. For example, one set of targeting criteria may be used during one period of time of the content delivery campaign and another set of targeting criteria may be used during another period of time of the campaign. As another example, a content delivery campaign may be associated with multiple content items, one of which may be associated with one set of targeting criteria and another one of which is associated with a different set of targeting criteria. Thus, while one content request from a client device may not satisfy targeting criteria of one content item of a campaign, the same content request may satisfy targeting criteria of another content item of the campaign.

Different content delivery campaigns that a content delivery exchange manages may have different compensation schemes. For example, one content delivery campaign may compensate the content delivery exchange provider for each presentation of a content item from the content delivery campaign (referred to herein as cost per impression or CPM). Another content delivery campaign may compensate the exchange provider for each time a user interacts with a content item from the content delivery campaign, such as selecting or clicking on the content item (referred to herein as cost per click or CPC). Another content delivery campaign may compensate the exchange provider for each time a user performs a particular action, such as purchasing a product or service, downloading a software application, or filling out a form (referred to herein as cost per action or CPA). The content delivery exchange may manage only campaigns that are of the same type of compensation scheme or may manage campaigns that are of any combination of the three types of compensation scheme.

### Rendering Service

In an embodiment, instead of implementing similar data retrieving and rendering functionality in each front-end service 112-118, such operations are implemented separately by another service, rendering service 120. Thus, each of front-end service 112-118 calls rendering service 120 when the front-end service identifies a content delivery campaign or a content item to retrieve. Such a call may involve passing an identifier (that identifies a campaign or a content item) and, optionally, type data that indicates a type of content item is to be retrieved and rendered or that identifies the caller (or which front-end service). Thus, a developer of a front-end service is not required to know how to access storage for a particular content item or how to render the particular content item.

Rendering service 120 may determine a type of content item based on an identifier in the call alone. For example, an identifier may identify a content delivery campaign and rendering service 120 uses the identifier to retrieve data about a corresponding content delivery campaign from a campaign database. Each content delivery campaign is associated with at least one content item identifier, which rendering service 120 uses to retrieve data about a corresponding content item from a content item database. Either the campaign data or the content item data indicates a type of content item.

Once data about a content item is retrieved, rendering service 120 renders (or formats) the content item based on the type of content item. Different content items will be formatted on a display differently. For example, sponsored updates are formatted differently than text ads.

Rendering service 120 may be implementing using multiple instances running on the same machine (or computing device) and/or on different machines. Thus, rendering service 120 may receive and process calls from front-end services 112-118 concurrently.

### Example Rendering Process

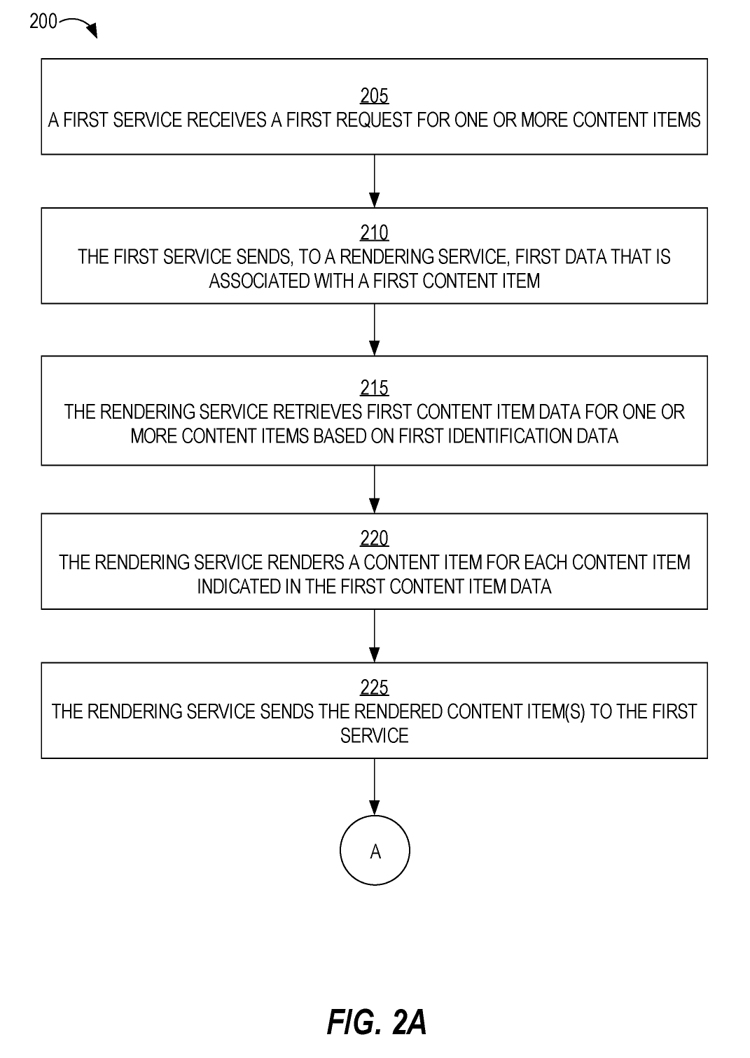

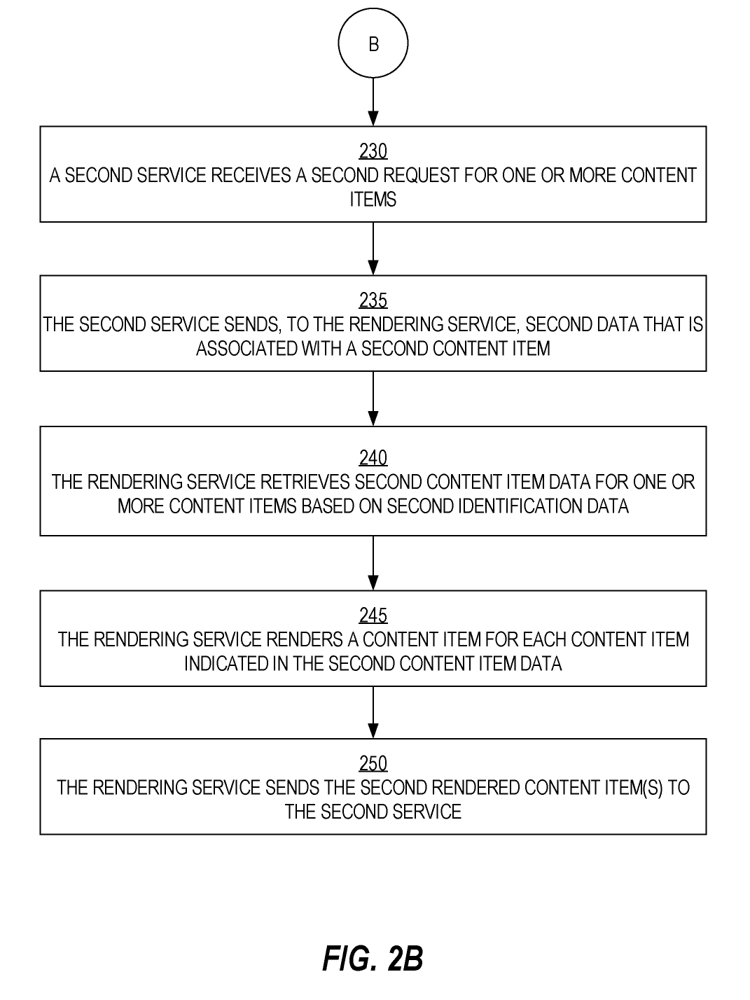

FIG. 2 is a flow diagram that depicts a process 200 for unified data rendering, in an embodiment.

At block 205, a first service (e.g., front-end service 112) receives a first request for one or more content items. The request may originate from a client device or other computing device over a network. The request may not specify any content items. Instead, the first service is responsible for identifying one or more content items, based, for example, on data contained within the request, such as a client device identifier, a user identifier, and/or attribute data that indicates one or more attributes or characteristics of a client device (upon which the content item(s) will be displayed) and/or user of the client device.

At block 210, in response to receiving the first request, the first service sends, to a rendering service (e.g., rendering service 120), first data that is associated with (e.g., identifies) a first content item. Block 210 may involve the first service determining which content item(s) to display or which content delivery campaign(s) are applicable to the first request. This determination may be based on data within the first request, data that the first service retrieves based on the data within the first request, and/or targeting criteria associated with each of multiple content delivery campaigns.

For example, a first request includes an entity (or member) identifier and front-end service 112 retrieves, from a profile database, based on the entity identifier, a profile of a particular entity identified by the entity identifier. Examples of entities include a user, an organization (e.g., a company or academic institution), or a group (of users and/or organizations). For each campaign of multiple content delivery campaigns, targeting criteria associated with the campaign is compared to data within the profile of the particular entity. If the targeting criteria of a campaign are satisfied (at least in the part), then the campaign is identified as a candidate campaign. Once a set of campaigns is identified in this manner, the first service may further filter the set of campaigns to remove campaigns based on one or more other criteria, such as resource availability associated with each campaign, frequency caps associated with each campaign, and projected/predicted revenue of each campaign.

Regardless of how one or more content delivery campaigns are identified, block 210 may involve the first service sending, to the rendering service, identification data that identifies the one or more campaigns or one or more content items that are associated with the one or more campaigns.

Block 210 may also involve the first service initiating the establishment of a network connection with the rendering service. The network connection enables the first service to send data to and receive data from the rendering service. Embodiments are not limited to any type of network connection.

In an embodiment, block 210 involves a REST (representational state transfer) API call, where an example endpoint name for the rendering service is “/renderedContentItems,” an example key of the call includes a URN (or uniform resource number) of a content item or a content delivery campaign, and example supported methods include get and batch_get. One example parameter of the call includes a data format. The data format specifies which rendered format should be used, where possible values include “HTML” and “JSON” (JavaScript Object Notation), which may be a default value. For example, if no value for data format is specified or indicated in the call, then the rendering service may presume that the rendering service should format the content item(s) using JSON.

Another example parameter of the call includes a member identifier, which identifies a registered member or user of a social network service. A member identifier is optional and specifies which user or member is to view the to-be-rendered content item(s). A member identifier might not be used in all rendering cases, such as where content is not dynamically changed based on member data.

At block 215, the rendering service retrieves content item data for one or more content items based on identification data. The content item data may indicate a single content item or multiple content items. Block 215 may involve sending the identification data to another service or data storage and receiving the content item data from the other service or data storage. If block 210 involved only identifying one or more content delivery campaigns, then block 215 may involve using the identification data to retrieve one or more content item identifiers associated with the identified campaign(s) and then retrieving the content item data based on the one or more content item identifiers. At least one of the identified campaigns may be associated with multiple content items, all of which may be displayed or only a subset of which may be displayed.

A content item of a content delivery campaign may be static in that the content item may not change depending on the user that is to view the content item or the context of the page in which the content item is to appear. Alternatively, a content item may be dynamic such that the content item contains data items that are different depending on the user viewing the content item and/or the context of the page in which the content item appears. For example, a content item may include a name of a user that is to view the content item, a name of a university that that user attended, and/or a name of a company that is mentioned in an article that that user is viewing.

A “dynamic” content item of one type may be different than a dynamic content item of another type. For example, one dynamic content item may include a first and last name of a user while another dynamic content item may include only a first name, while other dynamic content item does not include a name of any user.

Thus, block 215 may also involve retrieving content item data based on the type of content item. For example, if a content item is of a first type, then a first set of content item data is retrieved and if a content item is of a second type, then a second set of content item data is retrieved.

At block 220, the rendering service renders a content item for each content item indicated in the retrieved content item data. Thus, the rendering service implements the rendering logic that dictates how content items are formatted, once the appropriate data items within a content item are determined.

How the rendering service renders a content item depends on the type of content item. The rendering service may determine the type of content item in one of multiple ways. For example, the type of a content item may be determined based on (a) type data contained within a campaign database that the rendering service may have accessed for retrieving one or more content item identifiers, (b) the type of data items contained within the content item data, or (c) which front-end service called the rendering service. The identity of the calling service may be indicated in the initial request.

The format of a content item is dictated by the content item's type. Example formatting parameters include size of the content item (e.g., x and y dimensions), font size, font color, background color, location of any graphic within the content item, location of any text within the content item, location of any image (e.g., a profile picture) within the content item. As a specific example, a content item of a first type may include a last name followed by a first name while a content item of a second type may include a last name with no first name. Thus, different types of content items may contain different types of data or amount of data. If two types of content items contain the same amount and type of data, then the way the data within each content item is formatted or arranged is different.

Block 220 may also involve populating the formatted data into a viewable template using HTML, JSON, or other data format (e.g., as indicated in the initial request, if so). Different front-end services may require different data formats. For example, front-end service 112 may expect data formatted (or organized) in JSON while front-end service 116 may expect data formatted (or organized) in HTML.

In an embodiment, the rendering service is implemented using three different components: a data gathering component, a rendering component, and a view component. This is similar to the software architectural pattern referred to as MVC (or model-view-controller), which is used for implementing user interfaces. MVC divides a given software application into three interconnected parts, so as to separate internal representations of information from the ways that information is presented to or accepted from the user. The central component of MVC, the model, captures behavior of the application in terms of its problem domain, independent of the user interface. The model directly manages the data, logic, and rules of the application. The view can be any output representation of information, such as a chart or a diagram. Multiple views of the same information are possible, such as a bar chart for management and a tabular view for accountants. The controller accepts input and converts the input into commands for the model or view.

In addition to dividing the application into three different components, the MVC design defines the interactions between them. A model stores data that is retrieved according to commands from the controller and displayed in the view. The view generates new output to the user based on changes in the model. The controller sends commands to the model to update the model's state (e.g. editing a document). The controller can also send commands to the view to change the view's presentation of the model (e.g. by scrolling through a document).

At block 225, the rendering service sends the formatted content item(s) to the first service.

Blocks 230-250 are similar to blocks 205-225, except that a second service (that is different than the first service, such as front-end service 114) receives a second request and communicates with the rendering service. While content item(s) associated with the first request may be of a first type, content item(s) associated with the second request may be of a second type that is different than the first type. Also, the second request may indicate a different content item, a different member identifier, and/or a different data format than the first request. Thus, whereas front-end services previously implemented the data gathering, data rendering, and data populating steps, at least a subset of those steps are instead implemented by the rendering service.

### Caching

In an embodiment, a service (e.g., rendering service 120 or front-end service 112) retrieves data from one or more data sources and caches at least a portion of the data in one or more caches or temporary storage. “Caches” as described herein do not include cache memory that is used by a CPU to store data that is recently read from RAM memory. Instead, a cache that is leveraged by a service as described herein may include temporary storage that resides on a device that is separate from the device upon which an instance of the service is executing. Data that can be cached is the same as data that can be persistently stored, examples of which can be cached include member data (e.g., profile data), campaign data about one or more content delivery campaigns, and content item data about one or more content items associated with one or more content delivery campaigns.

One approach for implementing caching is requiring a service to store retrieved data in a cache and maintain the cache. For example, rendering service 120 receives a request and, because there is a cache, checks the cache for certain data. If the certain data is stored in the cache, then the data is retrieved and processed. Otherwise, rendering service 120 determines that the data is not stored in the cache (a cache miss) and then checks another cache or sends a request to a service or data source that should contain the requested data. After receiving the requested data, rendering service 120 causes the received data to be stored in the cache. If there are multiple layers of caching, developing such complex logic becomes more tedious and time consuming, which increases the likelihood of logic errors appearing in the code of the service.

### Simplifying Cache Management

In an embodiment, the details of reading from a cache and updating a cache are handled by a process or component that is different than the service or application that processes data stored in the cache. In this embodiment, a data source is modeled as a resource with one or more data layers associated therewith. Examples of data sources include (1) databases or file systems where certain data is ultimately stored and (2) certain services that have access to that data. For example, one data source may be a campaign database that stores data about multiple content delivery campaigns while another data source may be a content item database that contains data about multiple content items, each of which is associated with a content delivery campaign indicated in the campaign database.

Each resource is associated with configuration data (“resource configuration data”), which may be reflected in a file. Resource configuration data comprises one or more configurations or configuration data items. A developer of the service that relies on a resource may be responsible for establishing one or more configurations in the resource configuration.

One configuration within resource configuration data is a set (or list) of one or more data layers in which data from the associated resource may be persistently stored or cached or stored temporarily. Such a configuration is referred to herein as a “list configuration.” Examples of data layers include local memory, different types of caches, a database, and a file system. Thus, a data layer may be a data source (that stores the “ultimate truth” about a set of data) or a temporary storage (e.g., a cache) that stores data (e.g., temporarily) that is retrieved from a data source. Temporary storage may simultaneously store (or cache) data from multiple data sources.

If there are multiple data layers indicated in a list configuration, then the set or list of data layers may be ordered based on size, speed, or latency of each data layer in the set. For example, the first data layer in a list may be the one that logic (in a code library), when reading the resource configuration data for the resource, checks first for a data object before checking any other data layers in the list for the data object, while the second data layer in the list is the one that the logic checks second for the data object if the data object is not found in the first data layer, and so on.

A data object comprises one or more data items. A data item may be any type of data, such as text, an image, a graphic, audio, or video. Examples of implementations of a data object include a row (that includes one or more fields for one or more columns) in a relational database and an object in an object-relational database. For example, a data object in a member database may comprise multiple data items of a registered member, such as a member identifier (that uniquely identifies a member from other registered members), a first name, a last name, a profile picture, an employer name, a work industry, an employment status, an academic institution attended, one or more skills, one or more endorsements provided by other users or registered members. As another example, a data object in a campaign database may comprise a campaign identifier (that uniquely identifies a campaign from other content delivery campaigns), a provider or originator of the campaign, a duration or start date of the campaign, a target audience or targeting criteria of the campaign, one or more item identifiers that identify one or more content items associated with the campaign, type data that indicates a type of campaign (e.g., a text ad campaign, a sponsored update campaign, a dynamic ad campaign), pricing type data that indicates a pricing type (e.g., CPM, CPC, or CPA), and/or a status indicator that indicates whether the campaign is active.

Resource configuration data may also include a configuration for extracting one or more portions of a data object. Such a configuration is referred to as a “portion extraction configuration” or PEC. A PEC may identify one or more portions, such as one or more fields of an object or one or more columns of a row. Thus, a portion corresponds to a particular data item within a data object. A PEC is useful when a service does not need all the data items within a data object. For example, a PEC for a member database may indicate a first name and a profile picture. As a result of processing a PEC, only those two data items from a member's profile will be retrieved (or cached).

Resource configuration data may also include size data, and version data, which will be described in more detail hereinafter. Size data indicates how much memory to allocate to a cache.

For each data layer indicated in a list configuration, the resource configuration data may (or may not) indicate one or more configurations of the data layer, such as a TTL (“time to live” or a period of time in which a data item is to be stored in, or maintained by, the data layer) and connection data (that indicates how to establish a data connection with the data layer). For example, one data layer may be associated with a TTL of 20 milliseconds and another data layer may be associated with a TTL of two hours.

In an embodiment, each of one or more data layers may be associated with configuration data that is separate from (e.g., stored in a different configuration file) resource configuration data. The configuration data of a data layer (“data layer configuration data”) may also contain a TTL, a PEC, connection data, size data, and/or version data.

Data layer configuration data for a particular data layer may be considered default data if a set of resource configuration data does not contain the corresponding information. For example, if the resource configuration data of a resource does not contain a TTL for a particular data layer, then a TTL indicated in data layer configuration data of the particular data layer will be used instead. As another example, if the resource configuration data does not contain a PEC for a particular data layer, then a PEC indicated in data layer configuration data of the particular data layer will be used.

If there is a conflict between two configurations of the same data layer, then one of the two configurations will be overridden. For example, a configuration in data layer configuration data that conflicts with a configuration in a set of resource configuration data (for a particular resource) will be overridden or ignored. However, that configuration in the data layer configuration data may be used when a different resource is involved, such as when the resource configuration data for the different resource is silent with respect to that type of configuration.

A developer of the service (e.g., rendering service 120) that relies on the software framework to retrieve data from a resource (or data source) may specify the associated configurations or a person other than any developer of the service. The service merely needs to call a method (e.g., “get”) associated with a resource and specify an identifier or key of a data item to retrieve. Resource configuration data and/or data layer configuration data in combination with the software framework effectively creates a set of chained data layers and implements the reads from, and the writes to, each data layer. In this way, a developer of the service is not required to write the code for establishing connections to each data layer, reading data from each data source, and writing data to each data source. Instead, the developer may rely on a code library to perform such functions.

A “code library” is a collection of implementations of behavior, written in terms of a language, that has a well-defined interface by which the behavior is invoked. As long as a higher level program uses a code library to make calls, the code library does not need to be re-written to implement those calls over and over again. In addition, the behavior is provided for reuse by multiple independent programs. A program invokes the library-provided behavior via a mechanism of the language. For example, in an imperative language, such as C, the behavior in a code library is invoked by using C's normal function-call. What distinguishes the call as belonging to a code library, versus being to another function in the same program, is the way that the code is organized in the system. Library code is organized in such a way that the code can be used by multiple programs that have no connection to each other, while code that is part of a program is organized to only be used within that one program.

The code library that is separate from a service and that implements storage and caching management is referred to herein as a “resource data manager.” Multiple services may leverage or take advantage of the resource data manager. The code for the resource data manager may be one of multiple sets of code in the code library, each set of code performing a different set of functions, which may be completely unrelated to managing the retrieval and caching of resource data. The code for the resource data manager may be statically linked or dynamically linked with the code of the service.

The following is a specific example of how chaining data layers during execution of a service may be implemented. A resource may be a member database that stores profile data about multiple members or registered users of a social network provider. A resource configuration file associated with the resource specifies three data layers: a guava cache, a couchbase cache (another layer of caching), and a third layer, which is a “source of truth” (where the profile data is ultimately stored and from where the other data layers get the profile data to store). Examples of a third layer include an Oracle database layer and an API of another service. A developer of a service (e.g., rendering service 120) specifies code that, when executed, creates a resource object that is of the resource class and is associated with the resource configuration file.

When the service calls a get method of the resource object and passes a member identifier as part of the call, the resource data manager (associated with the resource class and part of the software framework of the service) reads the resource configuration file to determine which data layer to check first for profile data associated with the member identifier. If the resource configuration file includes connection data regarding how to connect to the first data layer, then the resource data manager uses that configuration file to establish a connection. Otherwise, the resource data manager uses a configuration file associated with the first data layer to establish the connection. The resource data manager also implements reads to, and writes from, the data layer. The resource data manager may leverage the resource's configuration file (or the data layer's configuration file) to determine which portions of a member profile to retrieve from the data layer. If the resource data manager determines that the member identifier is not found in the first data layer (e.g., the read with the member identifier results in a negative result, such as a NULL value), then the resource data manager identifies the second data layer based on the resource configuration file and uses the resource configuration file (or the second data layer's configuration file) to establish a connection. The process repeats until the profile data of the member is located, which may be at the second data layer or a subsequent data layer.

If the resource data manager retrieves requested data from a data layer that is different than the first data layer, then the resource data manager updates the first data layer with the requested data. Such updating may involve establishing a connection with the first data layer and transmitting the requested data to the first data layer through the connection. If there are multiple data layers in which the requested data is not found, then the resource data manager updates each of the multiple data layers with the requested data.

In the foregoing software architecture, a software developer of a service does not need to compose logic for retrieving data from multiple data layers or managing the caching of the data in one or more caching layers. Instead, one call to retrieve a set of data (e.g., profile data of a member, content item data of a content item, or campaign data of a content delivery campaign) results in the retrieval of the data item and, in some cases, the update of one or more caching layers.

### Clearing a Cache

In some situations, data in a cache or a data source is bad or incorrect. For example, the wrong data is retrieved from storage or written to a cache. To resolve the issue, the cache is cleared and any logic that caused the incorrect data to be written or retrieved is corrected. However, clearing a cache is not a trivial task and may be relatively time consuming.

In an embodiment, a cache is cleared by adding version data to each key that is stored in the cache. For example, when storing a key and its associated data item(s) in a cache, version data is first appended to the key and then the key with the version data is added to the cache. Later, when it is determined that contents of the cache are bad or incorrect, then the version data is changed (e.g., incremented or decremented) and subsequent keys that are received are modified by adding the changed version data to the keys.

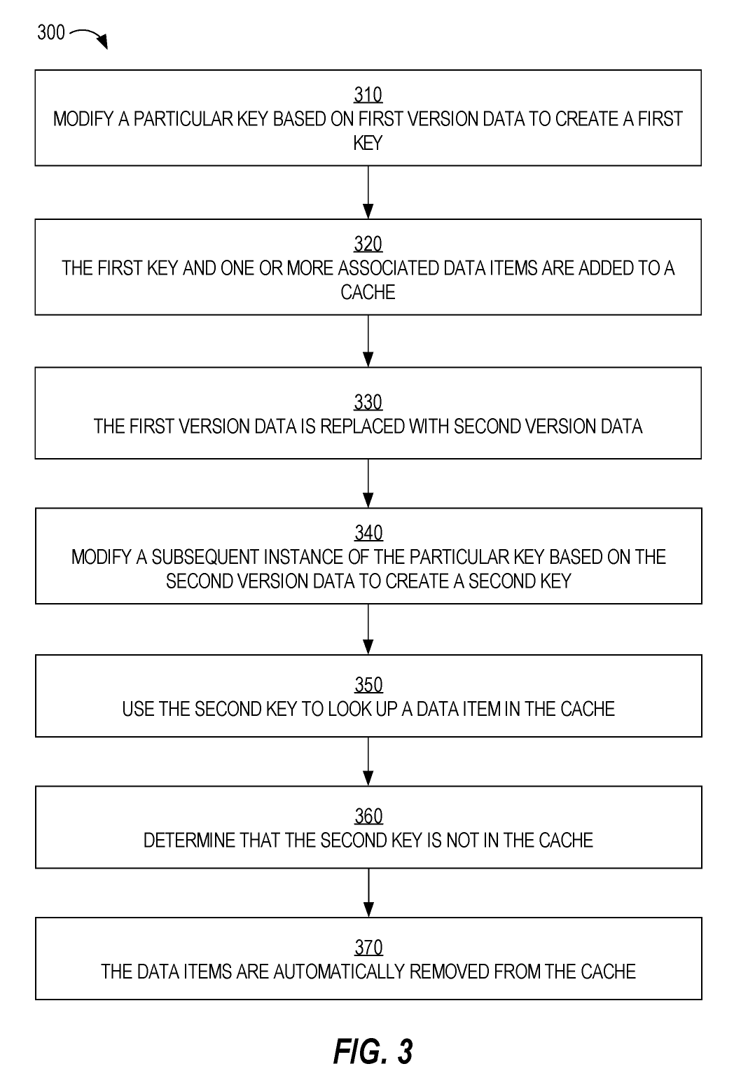

FIG. 3 is a flow diagram that depicts a process 300 for clearing a cache, in an embodiment. Process 300 may be implemented, at least partially, by a front-end service or a separate service, such as rendering service 120.

At block 310, a particular key is modified based on first version data to create a first key. The particular key may be modified by appending the first version data to the particular key. Other techniques for modifying the particular key may be used, such as using a particular hash function, in which case the first version data is part of the particular hash function. Block 310 may involve one service receiving the particular key from another service along with a request for certain data or for certain data processing. Process 300 may begin with the first version data being stored or at least accessible to the program that implements block 310.

At block 320, the first key and one or more associated data items are added to a cache. Block 320 may first involve determining that the first key is not found in the cache and, as a result, retrieving a data object or one or more data items from a data source based on the particular key, not the first key.

At block 330, after the first key and the associated data item(s) are added to the cache, the first version data is replaced with second version data that is different than the first version data. Block 330 may involve receiving user input to change the first version data. The user input may cause (regardless of the actual content of the user input) the version data to change, such as incrementing by a fixed amount (e.g., one), decrementing by one, or generating a random number. Alternatively, content of the user input might indicate (directly or indirectly) what the new version data will be. Either way, the user input may be specified in a request that the service (that is creating the modified keys) receives, similar to requests that the service receives from other services. For example, the request may be a REST API call that the service supports, such as a “/versionChange” endpoint that takes no parameters as input.

At block 340, a subsequent instance of the particular key is modified based on the second version data to create a second key. Block 340 may again involve one service receiving the particular key from another service along with a request for certain data or for certain data processing.

At block 350, the second key is used to look up the data item in the cache. Block 350 may involve the service or program that creates the second key to send, to a caching system that includes the cache, a request for any data items associated with the second key.

At block 360, because the second key is not found in the cache (at least initially), a cache miss occurs. Block 360 may involve the service or program receiving, from the caching system, a response that indicates that the second key is not in the cache.

At block 370, the associated data item(s) are (eventually) automatically removed from the cache, without any explicit external instruction to do so, other than a TTL that applies to all data items in the cache.

As a specific example, the key 123 (representing a campaign identifier) is appended with a 5 and added to a cache (e.g., as 123_5). Whenever the key 123 is received, the version number is appended to the key and the modified key is used to lookup up the associated data item(s) in the cache. Later, the version number is updated to 6. Then, if the key 123 is received, the key is appended with a 6 and the modified key is used to lookup the associated data item(s) in the cache. Because 123_6 does not exist in the cache, a cache miss will result and a data source will be eventually called to return a data object associated with key 123. If there are multiple data layers “before” the data source, then the modified key may cause a cache miss for each data layer. The data item(s) associated with the key 123_5 will be automatically removed from the cache based, for example, on a TTL value. (During service start-up, the service reads the configuration file and then instantiates each data level component with the specified configuration. In the above example regarding a guava cache, the guava cache would be instantiated and configured with the specified TTL.)

Adding version data to a key may be performed by a resource data manager (such as the resource data manager described herein) or by a service that processes the data associated with the key.

Version data may be reflected in resource configuration data or in data layer configuration data, regardless of whether a resource data manager is implemented. User input may cause the version data (in addition to other data) in configuration data to be updated. An administrator of server system 100 may provide the input. For example, a user changes a version number in a set of resource configuration data. Then, when a resource data manager analyzes the set of resource configuration data, the resource data manager uses the changed version data to add to subsequent keys.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

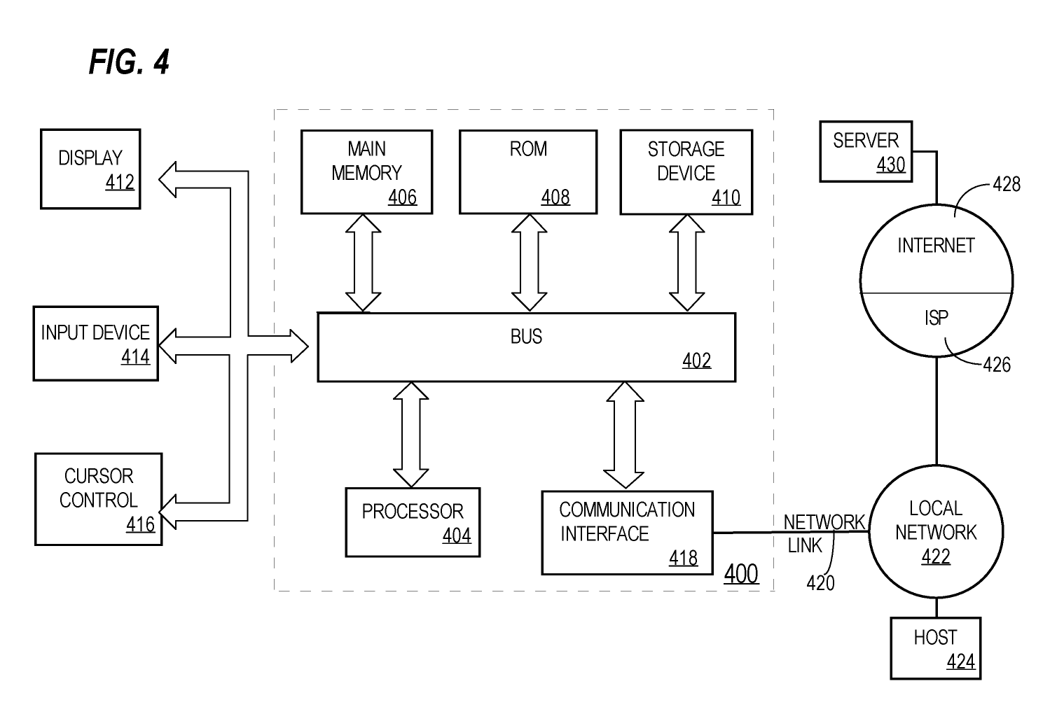

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A system comprising:
one or more processors;
one or more storage media storing instructions which, when executed by the one or more processors, cause:
initiating a call, by a service, to a method of an object that represents a resource, wherein the call includes identification data that identifies a set of data;
in response to receiving the call, reading, by a resource data manager that is separate from the service, resource configuration data that is associated with the resource and identifying, within the resource configuration data, a plurality of data layers that includes a first data layer and a second data layer;
establishing, by the resource data manager, a connection with the first data layer;
sending, by the resource data manager, to the first data layer, the identification data;
receiving, by the resource data manager, the set of data from one of the plurality of data layers;
sending, by the resource data manager, to the service, the set of data.

2. The system of claim 1, wherein the instructions, when executed by the one or more processors, further cause:
determining, by the resource data manager, whether the first data layer stores the set of data;
in response to determining that the first data layer does not store the set of data:
identifying, based on the resource configuration data, the second data layer;
establishing a connection with the second data layer;
sending the identification data to the second data layer.

3. The system of claim 2, wherein the instructions, when executed by the one or more processors, further cause, after sending the identification data to the second data layer:
receiving the set of data from a data layer, of the plurality of data layers, that is different than the first data layer;
in response to receiving the set of data, causing, by the resource data manager, the first data layer to store the set of data.

4. The system of claim 1, wherein the resource configuration data indicates one or more of:
a time to live for data items in one of the plurality of data layers;
one or more portions of a data object to extract from one of the plurality of data layers; or
a version of data objects to be stored in one of the plurality of data layers.

5. The system of claim 1, wherein the instructions, when executed by the one or more processors, further cause:
using, by the resource data manager, layer configuration data to interact with a particular data layer of the plurality of data layers, wherein the layer configuration data is associated with the particular data layer and is different than the resource configuration data.

6. The system of claim 5, wherein a conflict exists between a first configuration in the resource configuration data and a second configuration in the layer configuration data:
determining, by the resource data manager, to use the first configuration instead of the second configuration.

7. A system comprising:
one or more processors;
one or more storage media storing instructions which, when executed by the one or more processors, cause:
receiving, by a first service, a first request for one or more content items;
in response to receiving the first request:
determining, by the first service, a first content item to display in response to the first request;
sending, by the first service, to a particular service, first data that is associated with the first content item;
retrieving, by the particular service, first content item data for the first content item;
determining, for the first content item, a first type of content item from among a plurality of types of content items;
based on the first type of content item:
determining, by the particular service, how to format the first content item data;
generating, by the particular service, a first rendered content item;
sending the first rendered content item to the first service;
receiving, by a second service that is different than the first service, a second request for one or more second content items;
in response to receiving the second request:
determining, by the second service, a second content item to display in response to the second request;
sending, by the second service, to the particular service, second data that is associated with the second content item;
retrieving, by the particular service, second content item data for the second content item;
determining, for the second content item, a second type of content item from among the plurality of types of content items, wherein the second type is different than the first type;
based on the second type of content item:
determining, by the particular service, how to format the second content item data;
generating, by the particular service, a second rendered content item;
sending the second rendered content item to the second service.

8. The system of claim 7, wherein determining the first type of content item is based on an identity of the first service or based on a type of content delivery campaign with which the first content item is associated.

9. The second of claim 7, wherein:
sending the first data to the particular service comprises sending an indication of a particular data format;
generating the first rendered content item is further based on the particular data format.

10. The system of claim 9, wherein the particular data format is one of HTML or JSON.

11. The system of claim 7, wherein sending the first data to the particular service comprises sending an identifier of a registered member of a social network service.

12. The system of claim 7, wherein retrieving the first content item data comprises:
sending, by the particular service, the first data to a first data source;
receiving, by the particular service, item identification data from the first data source;
sending, by the particular service, the item identification data to a second data source;
receiving, by the particular service, the first content item data from the second data source.

13. The system of claim 12, wherein:
the first data source stores campaign data for each content delivery campaign of a plurality of content delivery campaigns;
the second data source stores content item data for each content item of a plurality of content items;
each content item of the plurality of content items is associated with a content delivery campaign in the plurality of content delivery campaigns.

14. A method comprising:
storing first version data;
receiving a first request that includes a particular key;
in response to receiving the first request:
retrieving, from a data source, one or more data items that are associated with the particular key;
modifying the particular key based on the first version data to create a first modified key;
causing the first modified key and the one or more data items to be stored in temporary storage that is separate from the data source;
after causing the first modified key and the one or more data items to be stored in temporary storage, modifying the first version data to create second version data that is different than the first version data;
after modifying the first version data, receiving a second request that includes the particular key;
in response to receiving the second request:
modifying the particular key based on the second version data to create a second modified key that is different than the first modified key;
determining whether the second modified key is stored in the temporary storage;
in response to determining that the second modified key is not stored in the temporary storage, retrieving, from the data source, one or more second data items that are associated with the particular key;
wherein the method is performed by one or more computing devices.

15. The method of claim 14, further comprising:
receiving user input that indicates a change to the first version data;
wherein modifying the first version data is performed in response to receiving the user input.

16. The method of claim 14, wherein determining whether the second modified key is stored in the temporary storage is performed while the first modified key is stored in the temporary storage.

17. The method of claim 14, wherein, after it is determined that the second modified key is not stored in the temporary storage, the first modified key is automatically removed from the temporary storage based on a TTL value associated with the temporary storage.
